(19) United States
(12) Patent Application Publication
(10) Pub. No.: US 2022/0051106 A1
(43) Pub. Date: Feb. 17, 2022

(54) METHOD FOR TRAINING VIRTUAL ANIMAL TO MOVE BASED ON CONTROL PARAMETERS

(71) Applicants: Inventec (Pudong) Technology Corporation, Shanghai (CN); INVENTEC CORPORATION, Taipei (TW)

(72) Inventors: Ying-sheng LUO, Taipei (TW); Trista Pei-Chun CHEN, Taipei (TW); Wei-Chao CHEN, Taipei (TW)

(21) Appl. No.: 17/132,067

(22) Filed: Dec. 23, 2020

Related U.S. Application Data
(60) Provisional application No. 63/064,503, filed on Aug. 12, 2020.

(30) Foreign Application Priority Data
Sep. 15, 2020 (CN) 202010967808.2

(51) Int. Cl. G06N 3/08; G06N 3/00; G06N 3/04

(52) U.S. Cl. CPC G06N 3/088; G06N 3/0454; G06N 3/008

(57) ABSTRACT

A method for training a virtual animal to move based on control parameters comprises an imitation learning stage and an adaptive control stage. The imitation learning stage includes obtaining a first momentum, a second momentum, a current state and a target state of a reference animal associated with the virtual animal, analyzing the first and second momentum to generate primitive distributions, and training a first gating network to generate a first primitive influence so as to convert the current state to the target state. The adaptive control stage includes obtaining a control parameter set, training a second gating network to generate a second primitive influence so as to convert the current state to a combination of the current state and the control parameter set, and generating a determination result according to the first and second primitive influences to update the second gating network.

### CROSS-REFERENCE TO RELATED APPLICATIONS

This non-provisional application claims priority under 35 U.S.C. § 119(e) on provisional application No. 63/064,503 filed in U.S.A. on Aug. 12, 2020, and on patent application No(s). 202010967808.2 filed in China on Sep. 15, 2020, the entire contents of which are hereby incorporated by reference.

### BACKGROUND

### 1. Technical Field

This disclosure relates to motion synthesis and character animation, and more particularly to a method for training a virtual animal to move based on control parameters.

### 2. Related Art

The quality of character animation in cartoons, video games, and digital special effects have improved drastically in the past decades with new tools and techniques developed by researchers in the field. Amongst various types of characters, quadrupeds are especially challenging to animate due to their wide variations of style, cadence, and gait pattern. For real-time applications such as video games, the need to react dynamically to the environments further complicates the problem.

Traditionally, to synthesize new animations from motion capture data, one would create an interpolation structure such as a motion graph, where the nodes represent well-defined actions from motion capture data, and the edges define the transition between the actions. Aside from the long and tedious process of labeling the graph, it is often difficult to acquire sufficient motion capture data for quadrupeds to cover different gait patterns and styles. Furthermore, the motion graph would become impractically big and complex in dynamic environments to take into account the numerous interactions between the agent and its surroundings. Despite the complexity, the motion graph would still not be useful for motion synthesis when unseen scenarios arise.

Research on the kinematic controller solves the labeling problem by reducing the need for crafting transitions between actions while allowing users to control the agent to produce the desired motions. But since a kinematic controller is designed to imitate the motion dataset, the agent would fail to respond naturally when it encounters unseen interactions between the agent and its surroundings in dynamic environments. For example, in a scenario involving a quadruped agent walking on a slippery, undulating boat, it would clearly be highly impractical to collect, or manually-design, enough reference motions to train the kinematic controllers. One can certainly resort to physics-based controllers to model complex phenomenon effectively, as a physical simulation enables the agent to produce meaningful reactions to external perturbations without the need to collect or animate such a reaction. Although, physical constraints such as gravity, friction, and collision introduce numerous difficulties in designing a physics-based controller.

### SUMMARY

Accordingly, this disclosure provides a method for training virtual animal to move based on control parameter, thereby solving problems of traditional methods.

According to one or more embodiment of the present disclosure, a method for training a virtual animal to move based on control parameters, wherein the virtual animal has a plurality of joints and the method comprises: an imitation learning stage and an adaptive control stage. The imitation learning stage includes: obtaining a first momentum, a second momentum, a current state and a target state; analyzing the first momentum and the second momentum to generate a plurality of primitive distributions by a primitive network; and training a first gating network to generate a first primitive influence according to the current state and the plurality of primitive distributions so as to convert the current state to the target state; wherein the first momentum is obtained when a reference animal performs a first action, the second momentum is obtained when the reference animal performs a second action, the reference animal is associated with the virtual animal, the current state and the target state are two states of the reference animal being continuously sampled in a time domain. The adaptive control stage includes: obtaining a control parameter set; training a second gating network to generate a second primitive influence according to the current state and the plurality of primitive distributions so as to convert the current state to a combination of the current state and the control parameter set; generating a determination result according to the first primitive influence and the second primitive influence by a discriminator; and updating the second gating network according to the determination result; wherein the determination result is configured to preserve the second primitive influence or generate another second primitive influence according to the current state and the plurality of primitive distributions so as to convert the current state to the combination of the current state and the control parameter set.

In view of the above description, the quadruped agent established according to the method proposed by the present disclosure can respond naturally to high-level controls in dynamic physical environments. The imitation learning stage of the present disclosure begins with a low-level imitation learning process to extract the natural movements perceived in the authored or captured animation clips. The adaptive control stage of the present disclosure uses a generative adversarial network (GAN) to map the high-level directive controls to action distributions that correspond to the animations. Further fine-tuning the controller with DRL enables it to recover from external perturbations while producing smooth and natural actions. The controller established according to the present disclosure may attach with navigation modules to enable it to operate autonomously for tasks such as traversing through mazes with goals. Equipped with natural movements, controllable, adaptive properties, the present disclosure propose a powerful tool in accomplishing motion synthesis tasks that involve dynamic environments.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of a virtual animal;

FIG. 2 is a flow chart of an embodiment of the present disclosure;

FIG. 3 is a detailed flow chart of the imitation learning stage S1;

FIG. 4 is a detailed flow chart of the adaptive control stage S2; and

FIG. 5 is a detailed flow chart of the fine-tuning stage S3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

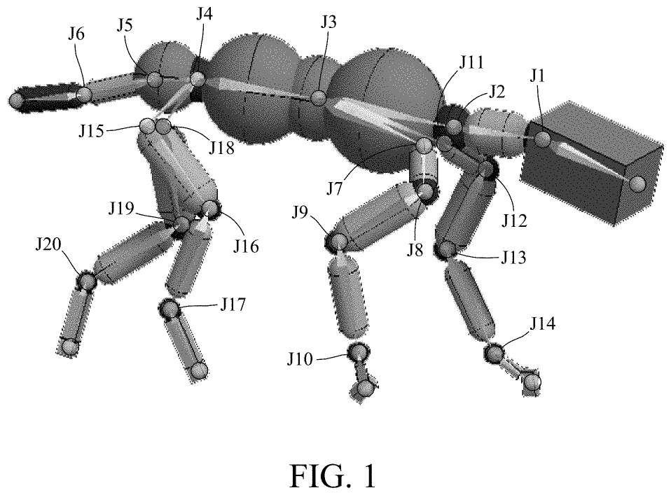

The present disclosure proposes a method for training a virtual animal to move based on control parameter, and said virtual animal have a plurality of joints as shown in FIG. 1. FIG. 1 shows a quadruped virtual animal with 20 joints J1-J20. A virtual motor may be installed on each joint. The present disclosure is configured to generate a controller, said controller controls the locomotion of the virtual animal by providing a rotation momentum to every virtual motor, so that each virtual motor generates a torque to drive the virtual animal to move according to control parameters.

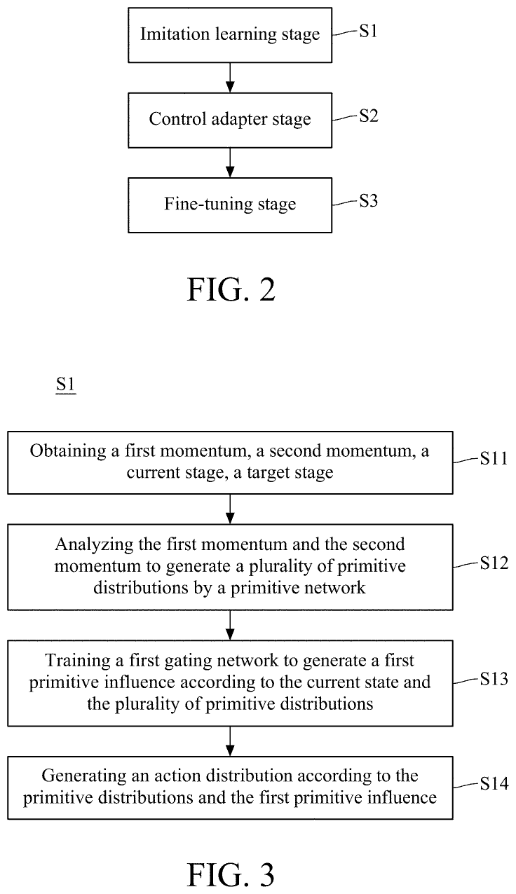

FIG. 2 is a flow chart of an embodiment of the present disclosure comprising three stages, an imitation learning stage S1, an adaptive control stage S2, and a fine-tuning stage S3.

FIG. 3 is a detailed flow chart of the imitation learning stage S1. Step S11 shows “obtaining a first momentum, a second momentum, a current stage, a target stage”. In an embodiment, each of the first and second momentum includes the measured data of each joint's position, velocity, rotation, and angular velocity. All the measured data are represented as 3-dimensional vector except for the rotations, which are represented as 4-dimensional quaternions. Step S11 is configured to obtain a momentum data and a state data when a reference animal performs the locomotion. The reference animal, such as a dog, is a real version of a virtual animal. An implementation example of step S11 is to set a plurality of sensors on the body of an animal in the real world to collect measurement data. Another implementation example of step S11 is as follows: momentum data and state data are obtained through physics engine simulation. The method of obtaining momentum data and state data in step S11 is not particularly limited in the present disclosure. Specifically, regarding each joint of the reference animal, the first momentum is obtained when a reference animal performs a first action, and the second momentum is obtained when the reference animal performs a second action. The reference animal is associated with the virtual animal. The first action and the second action last for a time interval such as 10 seconds. In short, the first and second momentum respectively correspond to two types of actions of the same joint of the reference animal. An example of the first and second action includes “walk” and “run”. Another example includes “trot at a speed of 1.5 meters per second” and “canter at a speed of 3 meters per second”. The momentum data obtained in step S11 at least comprises first and second momentum which belong two types of actions. However, the present disclosure does not limit the number of types of actions. For example, a third or a fourth momentum may be measured and used depending on the requirement.

Specifically, the current state and the target state are two states of the reference animal being continuously sampled in a time domain. Each of the current state and the target state is identical to the first or second momentum in respect to their data structure. In other words, each of the current state and the target state also includes data such as position, velocity, rotation and angular velocity. The difference is that the data of the current state and the target state are sampled in two consecutive timings while the data of the first and second momentums are measured for a period of time. In an embodiment, the current state and the target state can be extracted from the first or second momentum. For example, the first momentum is a 10-second trot movement, and the current state and target state are extracted from the first momentum at the third and fourth second.

Step S12 shows “analyzing the first momentum and the second momentum to generate a plurality of primitive distributions by a primitive network”. Step S13 shows “training a first gating network to generate a first primitive influence according to the current state and the plurality of primitive distributions”, so as to convert the current state to the target state. The primitive network and the gating network are two modules of a policy network. Regarding the implementation of the policy network, please refer to this document, “Xue Bin Peng, Michael Chang, Grace Zhang, Pieter Abbeel, and Sergey Levine. 2019. MCP: Learning Composable Hierarchical Control with Multiplicative Compositional Policies, In NeurIPS”. How the primitive network generates the primitive distributions and how the first gating network generates the first primitive influence are not described here.

Each primitive distribution is a basic unit of the action. In an embodiment, the primitive network P generates primitive distributions ϕ₁ . . . ϕₖ. Each primitive distribution ϕᵢ is modeled as a Gaussian distribution with state-dependent action mean μᵢ(sₜ) and diagonal covariance matrix Σᵢ, as shown in Equation 1. An embodiment of the present disclosure uses a fixed diagonal covariance matrix Σ, and thereby avoiding premature convergence due to modification of Σ during the training of the primitive network.

ϕᵢ=N(μᵢ(sₜ),Σᵢ), i=1,2 . . . k. (Equation 1)

A combination of one or more primitive distributions may control the virtual animal perform a specific action. The first gating network generates one or more primitive influences configured to combine one or more primitive distributions in step S13, as shown in Equation 2,

w=G_{low}(sₜ,c_{low}), (Equation 2)

wherein w is the first primitive influence, w∈R^{k}, k is the total number of primitive influences. In an embodiment, the number of first primitive influences equals to the number of primitive distributions. G_{low} is the first gating network. sₜ is the current state. c_{low} is the target state, and c_{low}=(ŝₜ₊₁,ŝₜ₊₂) is the joint-level control defined as the target states for the next two time steps of the reference motion. Both sₜ and ŝₜ contain the information of each joint's position, velocity, rotation, and angular velocity. sₜ represents the state at the t second, and c_{low} represents the state at the t+1 second and t+2 second.

Step S14 shows “generating an action distribution according to the primitive distributions and the first primitive influence”. Each of the primitive distributions and its corresponding first primitive influences may be multiplicatively composed to produce a composite distribution as shown in equation 3. This composite distribution shown in equation 3 is also a Gaussian distribution. The action distribution generated in step S14 may be served as a control instruction controlling the joint of the virtual animal.

$$π ( {a}_{t + 1} \vert {s}_{t} , {c}_{t} ) = \frac{1}{Z ( {s}_{t} , {c}_{t} )} {\prod }_{i = 1}^{k} {ϕ}_{i}^{{w}_{i}} \qquad ( Equation 3 )$$

wherein Z(sₜ, cₜ) denotes a normalization function, and cₜ denotes the current control objective, cₜ=c_{low}. The virtual animal's next action aₜ₊₁ is then sampled from this action distribution.

In an embodiment of the present disclosure, the imitation learning stage S1 further comprises three reward functions regarding pose, velocity and center-of-mass (COM), as shown in equation 4, equation 5 and equation 6.

$$\begin{matrix}{R}_{p} = exp [ - 2 ( {\sum }_{j} {‖ {\hat{q}}_{j} ⊖ {q}_{j} ‖}^{2} ) ] & ( Equation 4 ) \\ {R}_{v} = exp [ - 0.1 ( {\sum }_{j} {‖ {{q}^{{.}^{⋁}}}_{j} - {\dot{q}}_{j} ‖}^{2} ) ] & ( Equation 5 ) \\ {R}_{com} = exp [ - 10 ( {‖ {\hat{p}}_{c} - {p}_{e} ‖}^{2} ) ] & ( Equation 6 )\end{matrix}$$

The pose reward function Rₚ of equation 4 encourages the controller to match the target state's pose by computing the quaternion difference ⊖ between the virtual animal's joint orientations qⱼ and the target state's orientations \hat{q}ⱼ.

The velocity reward function Rᵥ of equation 5 computes the difference of joint velocities, where \dot{q}ⱼ and \hat{\dot{q}}ⱼ represent the angular velocity for the j-th joint of the virtual animal and the target respectively.

The center of mass reward function R_{com} discourages the virtual animal's center of mass p_{c} to deviate from the target state's center of mass \hat{p}_{c}.

In an embedment of the present disclosure, the end-effector reward function is replaced with a contact point reward function R_{c} as shown in equation 7,

$${R}_{c} = exp [ - \frac{{λ}_{c}}{4} ( {\sum }_{e} {\hat{p}}_{e} ⊕ {p}_{e} ) ] , {λ}_{c} = 5 , \qquad ( Equation 7 )$$

wherein ⊕ denotes the logical XOR operation, pe denotes the Boolean contact state of the virtual animal's end-effector, and e∈{left-front, right-front, left-rear, right-rear}. This reward function R_{c} is designed to discourage the virtual animal when the gait pattern deviated from the target pattern, and to help resolve the foot-sliding artifacts. For example, the Boolean contact state for only the left-front end-effector touches the ground can be denoted by p=[1, 0, 0, 0]. λ_{c} in equation 7 denotes a hyperparameter that controls the slope of the exponential function, and an embodiment of the present disclosure sets 5 to λ_{c} to yield the best outcome. The final form of the reward function is shown in equation 8.

R=0.65Rₚ+0.1Rᵥ+0.1R_{com}+0.15R_{c} (Equation 8)

To reduce the training complexity, the present disclosure separates the target state of each control objective. As a result, the physics-based controller obtained in the imitation learning stage S1 of the present disclosure can imitate the given target state by learning the corresponding primitive distributions and first primitive influences. The controller produces natural movements, performing different gait patterns depicted by the target state.

In an embodiment of the present disclosure, step S14 may be skipped and the adaptive control stage S2 is performed directly after step S13.

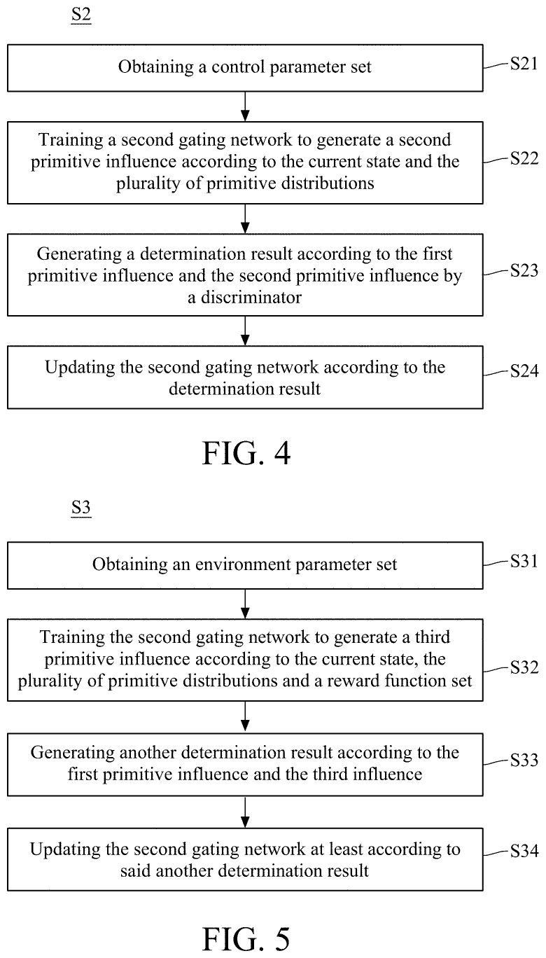

FIG. 4 is a detailed flow chart of the adaptive control stage S2. The adaptive control stage S2 includes steps S21-S24. Step S21 shows “obtaining a control parameter set”. The control parameter set may be derived from the target state C_{low}. The control parameter set includes a velocity and a heading of the virtual animal. In an embodiment, the controller parameter is represented as c_{high}=(σ, Δθ), wherein denotes virtual animal's target speed, and Δθ represents the angular difference between the virtual animal's current heading and target state's heading. For example, the control for the virtual animal to travel at 1 m/s while rotating 90 degrees counter-clockwise is c_{high}=(1,0.5π).

S22 shows “training a second gating network to generate a second primitive influence according to the current state and the plurality of primitive distributions”. Specifically, the second gating network should learn the mapping between the high-level user control and the primitive influence when the target state is replaced with the control parameter set, so that the second gating network may convert the current state to a combination of the current state and the control parameter set. It should be noticed that standard distance functions such as L1 or L2 only preserve the low-order statistics of a distribution and do not guarantee the samples are drawn from the correct distribution. Therefore, the present disclosure uses a generator of the generative adversarial network (GAN) as the second gating network. Given real samples of primitive influence wᵣₑₐₗ drawn from real data distribution wᵣₑₐₗ˜G_{low}(sₜ,c_{low}), the second gating network G_{high} of step S22 serves as the generator and produces the second primitive influence w_{fake} which is drawn from w_{fake}˜G_{high}(sₜ,c_{high}).

S23 shows “generating a determination result according to the first primitive influence and the second primitive influence by a discriminator”. In an embodiment of the present disclosure, both the second gating network and the discriminator D are modules of the GAN framework. The discriminator D aims to generate the determination result by maximizing an adversarial loss function L_{adv} defined in equation 9.

$$\begin{matrix}{min}_{{G}_{high}} {max}_{D} {L}_{adv} = {𝔼}_{{s}_{t} , {c}_{low}} [ log D ( {G}_{low} ( {s}_{t} , {c}_{low} ) ) ] + {𝔼}_{{s}_{t} , {c}_{low}} [ log ( 1 - D ( {G}_{high} ( {s}_{t} , {c}_{high} ) ) ) ] & ( Equation 9 ) \\ {L}_{rec} {‖ {w}_{fake} - {w}_{real} ‖}_{1} & ( Equation 10 ) \\ {L}_{G} = {λ}_{adv} * {L}_{adv} + {λ}_{rec} * {L}_{rec} & ( Equation 11 )\end{matrix}$$

The reconstruction loss L_{rec} of equation 10 calculates the absolute distance between the first primitive influence and the second primitive influence. In an embodiment of the present disclosure, the second gating network G_{high} is trained by minimizing the objective function defined in equation 11. Through the adversarial loss function L_{adv}, the discriminator D provides supervision to the generated second primitive influence by classifying it as real or fake. This guides the second gating network G_{high} to learn the real data distribution, i.e., the manifold. The value of λ_{rec} in equation 11 is set to 100, and the value of λ_{adv} is set to 1. Jointly minimizing the two loss functions L_{rec} and L_{adv} allows the second gating network to produce the second primitive influence that is close in terms of distance and also come from the real first influence primitive generated in the imitation learning stage S1.

S24 shows “updating the second gating network according to the determination result”. If the discriminator determines that the second primitive influence is available, this second primitive will be preserved. Otherwise, the second gating network generates another second primitive influence according to the current state and the plurality of primitive distributions and the discriminator determines that whether said second primitive influence is available to convert the current state to the combination of the current state and the control parameter set. For example, said another second primitive influence may be generated randomly, and the present disclosure does not limit thereof.

After step S24 is finished, another action distribution may be generated according to one or more primitive distributions and the second primitive influence generated by the updated second gating network and thus each joint of the virtual animal may be controlled. Said another action distribution generated after step S24 is similar to the action distribution generated in step S14. The difference is that said another action distribution further comprises the criteria obtained from GAN. The composition of said further another action distribution is identical to that of step S14.

In an embodiment of the present disclosure, after the imitation learning stage S1 and the control adaptor stage S2 are finished, a control adapter based on high-level user control is implemented to control the virtual animal's locomotion. In another embodiment, the present disclosure further comprises a fine-tuning stage S3 after the adaptive control stage S2. FIG. 5 is a detailed flow chart of the fine-tuning stage S3. The fine-tuning stage S3 comprises steps S31-S34 of FIG. 5.

Step S31 shows “obtaining an environment parameter set”. Similar to the aforementioned control parameter set, the environment parameter set also comprises the velocity and the heading of the virtual animal. The difference is that the environment parameter set reflect the information of larger number of scenarios. Specifically, in the adaptive control stage S2, the control parameter set only expose a small subset of possible scenarios to the controller. In order to let the virtual animal recover from unseen scenarios, the second gating network generated in the adaptive control stage S2 needs to be further fine-tuned.

Step S32 shows “training the second gating network to generate a third primitive influence according to the current state, the plurality of primitive distributions and a reward function set”, and thereby converting the current stage to an adapting state. The adapting state is a combination of the current state and the environment parameter set, and the virtual animal is in the adapting state in response to the environment parameter set. The reward function set comprises a speed reward function and a heading reward function as shown in equation 12 and equation 13.

$$\begin{matrix}{R}_{spd} = exp [ - {λ}_{spd} ( σ - {‖ v ‖}^{2} ] & ( Equation 12 ) \\ {R}_{head} = ( \frac{\hat{u} \cdot v}{‖ \hat{u} ‖ * ‖ v ‖} + 1 ) * 0.5 & ( Equation 13 )\end{matrix}$$

The speed reward R_{spd} computes the L2-distance between the target speed denoted by σ and the virtual animal's current movement speed ∥v∥. The value of λ_{spd} is set to 0.8 to produce the best result.

The heading reward R_{head} computes the cosine similarity between the target heading û=(cos(\hat{θ}), −sin(\hat{θ})) and virtual animal's heading v projected onto the plane of motion, with \hat{θ} representing the target heading in radians. The value of cosine similarity is normalized to be between 0 and 1.

Step S33 shows “generating another determination result according to the first primitive influence and the third influence”. Step S33 is basically the same as step S23 of the adaptive control stage S2 and does not be repeated here. Step S34 shows “updating the second gating network at least according to said another determination result”. In an embodiment of the present disclosure, the second gating network may be updated only according to said another determination result. In another embodiment of the present disclosure, updating the second gating network at least according to said another determination result comprises: updating the second gating network according to said another determination result and a regularization function. In step S34, a parameter of each primitive distribution is prohibited to be modified when updating the second gating network. In other words, since the tendency for the policy network is to change the primitive network to compensate for the gating network's error. Further, a high-level user control only affects the primitive influence. The present disclosure freezes the parameters of the primitive network and only train the gating network to preserve the action distribution. In addition, to ensure the controller does not deviate too far from the learned action distribution obtained in the adaptive control stage S2, the present disclosure imposes a regularization function L_{reg} as shown in equation 14.

$${L}_{reg} = {\sum }_{l = 1}^{L} {‖ {\hat{α}}_{l} - {α}_{l} ‖}_{1} \qquad ( Equation 14 )$$

\hat{α}ₗ denotes the parameters of l-th fully-connected layer of the GAN trained gating network, αₗ denotes the parameter of l-th fully-connected layer of the currently trained gating network, and L denotes the total number of layers in each gating network. The present disclosure applies the regularization in the parameter space, because applying it to the layer's output would penalize the real unseen scenarios. When the second gating network is updated respectively by the adaptive control stage S2 and the fine-tuning stage S3, using the regularization function L_{reg} would maintain the balance of both stages rather than overfitting the second gating network trained in the adaptive control stage S2 in the fine-tuning stage S3 performed later.

After step S34 is finished, further another action distribution may be implemented according to one or more primitive distributions and the second primitive influence generated by the updated second gating network, and thus each joint of the virtual animal can be controlled. Said further another action distribution is similar to the action distribution generated in step S14 or said another action distribution generated in step S24. The difference is that said further another action distribution further comprises the criteria obtained from the GAN and the deep reinforcement learning (DRL). The composition of said further another action distribution is identical to that of step S14.

In view of the above description, the quadruped agent established according to the method proposed by the present disclosure can respond naturally to high-level controls in dynamic physical environments. The imitation learning stage of the present disclosure begins with a low-level imitation learning process to extract the natural movements perceived in the authored or captured animation clips. The adaptive control stage of the present disclosure uses a generative adversarial network (GAN) to map the high-level directive controls to action distributions that correspond to the animations. Further fine-tuning the controller with DRL enables it to recover from external perturbations while producing smooth and natural actions. The controller established according to the present disclosure may attach with navigation modules to enable it to operate autonomously for tasks such as traversing through mazes with goals. Equipped with natural movements, controllable, adaptive properties, the present disclosure propose a powerful tool in accomplishing motion synthesis tasks that involve dynamic environments.

What is claimed is:

1. A method for training a virtual animal to move based on control parameters, wherein the virtual animal has a plurality of joints and the method comprises:
an imitation learning stage including:
obtaining a first momentum, a second momentum, a current state and a target state;
analyzing the first momentum and the second momentum to generate a plurality of primitive distributions by a primitive network; and
training a first gating network to generate a first primitive influence according to the current state and the plurality of primitive distributions so as to convert the current state to the target state;
wherein the first momentum is obtained when a reference animal performs a first action, the second momentum is obtained when the reference animal performs a second action, the reference animal is associated with the virtual animal, the current state and the target state are two states of the reference animal being continuously sampled in a time domain; and
an adaptive control stage including:
obtaining a control parameter set;
training a second gating network to generate a second primitive influence according to the current state and the plurality of primitive distributions so as to convert the current state to a combination of the current state and the control parameter set;
generating a determination result according to the first primitive influence and the second primitive influence by a discriminator; and
updating the second gating network according to the determination result;
wherein the determination result is configured to preserve the second primitive influence or generate another second primitive influence according to the current state and the plurality of primitive distributions so as to convert the current state to the combination of the current state and the control parameter set.

2. The method of claim 1, further comprising a fine-tuning stage after the adaptive control stage, wherein the fine-tuning stage includes:
obtaining an environment parameter set;
training the second gating network to generate a third primitive influence according to the current state, the plurality of primitive distributions and a reward function set so as to convert the current state to an adapting state;
generating another determination result according to the first primitive influence and the third primitive influence; and
updating the second gating network according to said another determination result at least;
wherein the adapting state is a combination of the current state and the environment parameter set, and the virtual animal is in the adapting state in response to the environment parameter set.

3. The method of claim 1, wherein the imitation learning stage further includes:
generating an action distribution according to the plurality of primitive distributions and the first primitive influence, with the action distribution comprising an output momentum of each joint.

4. The method of claim 1, wherein the control parameter set is derived from the target state, the control parameter set includes a velocity and a heading of the virtual animal, and the second gating network and the discriminator belong to a generating adversarial network.

5. The method of claim 2, wherein the environment parameter set includes a velocity and a heading of the virtual animal, and the reward function set comprises a velocity reward function and a heading reward function.

6. The method of claim 2, wherein updating the second gating network at least according to said another determination result comprises: updating the second gating network according to said another determination result and a regularization function.

7. The method of claim 1, wherein a parameter of each primitive distribution is prohibited to be modified when updating the second gating network.
